(19) United States
(12) Patent Application Publication
(10) Pub. No.: US 2005/0177693 A1
(43) Pub. Date: Aug. 11, 2005

(54) Asynchronous mirroring in a storage area network

(75) Inventor: Nelson Nahum, Irvine, CA (US)

Correspondence Address: FRISHAUF, HOLTZ, GOODMAN & CHICK, PC, 220 5TH AVE FL 16, NEW YORK, NY, 10001-7708, US

(73) Assignee: StoreAge Networking Technologies, Nesher (IL)

(21) Appl. No.: 10/776,715

(22) Filed: Feb. 10, 2004

(51) Int. Cl. G06F 12/16

(52) U.S. Cl. 711/162

(57) ABSTRACT

A method and a system for simultaneously mirroring of one or many data objects from one or many local storage devices (SDL) to one or many remote storage devices (SDRx). The one or many data objects may be used during mirroring. A mirroring functionality includes the application of a succession of freeze and copy procedures repeated sequentially in successive mirroring cycles. Only the last local updated mirrored version is saved in the remote storage device(s). Each new updated version overwrites the previous version. Mirroring is performed asynchronously in the background by freezing and copying successive discrete blocks of data. The mirroring functionality is operable to perform more than one mirroring operation simultaneously as well as simultaneous cross-mirroring.

### CROSS-REFERENCE TO RELATED APPLICATIONS

The present application is a Continuation application of International Application Serial No. PCT/IL02/00665, filed Aug. 13, 2002, which is based upon and claims the benefit of priority from prior U.S. Provisional Patent Application No. 60/312209 filed Aug. 14, 2001.

### TECHNICAL FIELD

The invention relates in general to the field of mirroring, or data replication, and in particular, to the asynchronous mirroring of data objects between storage devices coupled to a Storage Area Network (SAN) or to a network connectivity in general.

Glossary

A selected data object is a single data object, or a plurality, or a group, of data objects.

A data object is a volume, a logical or virtual volume, a data file, or any data structure. The terms data object and volume are used interchangeably below.

The term “local” is used to indicate origin, such as for a local storage device.

The term “remote” is used to indicate destination, such as for a remote storage device.

Storage devices are magnetic disks, optical disks, RAIDS, and JBODS.

The storage space for a data object may span only a part, or the whole, or more than the whole space contents of a storage device.

A computing facility or processing facility is a computer processor, a host, a server, a PC, and also a storage switch or network switch, a storage router or network router, or a storage controller. A computing facility may operate with a RAM for running computer programs, or operate with a memory and computer programs stored on magnetic or other storage means.

A network connectivity is a Local Area Network (LAN), a Wide Area Network (WAN), or a Storage Area Network (SAN).

### BACKGROUND ART

Prior art direct access storage systems that perform remote mirroring and storage from one storage device to a second storage device, such as from a local storage device to a remote storage device, stipulate requirements that are hard to cope with, some examples of which are described below.

For example, some systems require that the local and remote storage systems be homogeneous, meaning that the hardware at the local storage site and at the remote storage site must be of the same vendor. Other systems demand that before replication to a remote storage device, all the local data be sent to the local system. Still other systems need a synchronization system when a local volume spans across multiple storage systems, to keep the data consistent at the remote site. Further systems achieve data replication consistency between the one site and a remote site by queuing the I/O requests at the local site, which imposes huge storage resource demands, since the order of write commands must be preserved.

In U.S. Pat. No. 5,742,792 to Yanai et al., entitled “Remote Data Mirroring” there is disclosed a system for providing remote copy data storage. However, the system requires a dedicated data storage system controller. Furthermore, mirroring between the primary and the secondary data storage systems requires synchronization of these data storage systems before data is copied.

Micka et al. divulge remote data copying in U.S. Pat. No. 5,657,440, but their teachings require, among others, an updating system for providing sequence consistent write operations that needs a periodic synchronizing time-denominated check-point signal.

It would thus be advantageous to provide data replication facilities permitting the use of heterogeneous storage device hardware, with different topologies, procured from different vendors. Continuous replication is superfluous and it would be preferable to save replication made at discrete moments in time. Furthermore, saving of only the last made replication is usually sufficient, and may save storage volume. In addition, it would be best to prevent the requirement for a dedicated controller.

Such needs are addressed by the following disclosure.

### SUMMARY OF THE INVENTION

The disclosure presents a method to be implemented as a system to achieve mirroring, or replication, of a selected data object from a local storage device, to a remote storage device, by sequential freeze and copy of discrete blocks of data. During mirroring, the selected data object may be used uninterruptedly, since mirroring is transparent to the operating system. Copying of the successive discrete blocks of data is performed asynchronously and in the background.

It is an object of the present invention to provide a method and a system operative for mirroring a selected data object from at least one local storage device (SDL) into at least one remote storage device (SDRx). The at least one local storage device is coupled to a first processing facility (HL), and the at least one remote storage device is coupled to a second processing facility (HR). The at least one local storage device, the at least one remote storage device, the first and the second processing facility are coupled to a network connectivity comprising pluralities of users, of processing facilities and of storage devices. The method and the system comprise:

running a mirroring functionality in the first and in the second processing facility, the mirroring functionality comprising:
a freeze procedure for freezing the selected data object,
a copy procedure for copying the frozen selected data object into the at least one remote storage device,

permitting use and updating of the selected data object in parallel to running the mirroring functionality, and

commanding, by default, repeated run of the mirroring functionality for copying updates to the selected data object, unless receiving command for mirroring break, whereby the selected data object residing in the at least one local storage device is copied and sequentially updated into the at least one remote storage device.

It is a further object of the present invention to provide a method and a system for

applying the freeze procedure for freezing the selected data object as a source volume (SV),

creating at least one local auxiliary volume (AVL) to which updates addressed to the selected data object are redirected, each single data object out of the selected data object corresponding to one volume out of the at least one auxiliary volume,

creating at least one remote volume in each remote storage device out of the at least one remote storage device, to correspond to each one local auxiliary volume created,

forming in the at least one local storage device of at least one resulting source volume, comprising the frozen selected data object and the at least one local auxiliary volume, and

applying the copy procedure for copying the frozen selected data object from the at least one resulting volume into the at least one remote storage device.

The mirroring functionality is applied simultaneously to more than one data object, and from at least one local storage device to at least one remote storage device, and vice-versa.

It is another object of the present invention to provide a method and a system for:

applying the freeze procedure for freezing simultaneously more than one data object,

applying the copy procedure to copy simultaneously more than one frozen selected data object,

mirroring simultaneously one single data object residing in one local storage device into more than one remote storage device,

mirroring simultaneously a plurality of single data objects residing respectively in a same plurality of local storage devices into one remote storage device,

mirroring simultaneously a plurality of single data objects residing in one local storage device respectively into a same plurality of remote storage devices, and

mirroring simultaneously one single data object residing in each one local storage device out of a plurality of local storage devices into one remote storage device.

It is yet another object of the present invention to provide a method and a system for:

at a selected point in time:

starting a mirroring cycle,

freezing the selected data object,

creating at least one local auxiliary volume (AVL) in the at least one local storage device (SDL) and at least one remote volume (RV) in the at least one remote storage device (SDRx),

forming at least one resulting source volume comprising the frozen selected data object and the local auxiliary volume (AVL), and

after the selected point in time:

copying the frozen selected data object from the resulting source volume into the at least one remote volume until completion of copy,

redirecting to the local auxiliary volume of the updates addressed to the selected data object,

permitting use of the selected data object during mirroring, by associative operation with the resulting source volume, and

repeating a next mirroring cycle by default command, after completion of copy to the at least one remote storage device, unless receiving command for mirroring break.

It is yet an object of the present invention to provide a method and a system for:

starting a next mirroring cycle at a next point in time occurring after completion of copy to the at least one remote storage device (SDR),

freezing the resulting source volume,

creating an ultimate local auxiliary volume in the local storage device and an ultimate remote volume in the at least one remote storage device,

forming an ultimate resulting source volume comprising the penultimate resulting source volume and the ultimate local auxiliary volume (AVL), and

after the next point in time:

copying the penultimate local auxiliary volume into the ultimate remote volume, and,

redirecting to the ultimate local auxiliary volume of the updates addressed to the selected data object,

permitting use of the selected data object during mirroring, by associative operation with the ultimate resulting source volume, and

after completion of copy into the ultimate remote volume:

synchronizing the penultimate local auxiliary volume into the frozen selected data object,

synchronizing the at least one ultimate remote volume into the penultimate remote volume by command of the second processing facility (HR), and

repeating, by default command, of a next mirroring cycle after completion of copy to the at least one second storage device, unless receiving command for mirroring break.

It is still an object of the present invention to provide a method and a system for:

selecting still another point in time occurring after completion of copy of the penultimate local auxiliary volume,

freezing the resulting source volume,

creating an ultimate local auxiliary volume in the local storage device and an ultimate remote volume in the at least one remote storage device,

forming an ultimate resulting source volume comprising the penultimate resulting source volume and the ultimate local auxiliary volume, and

copying the penultimate local auxiliary volume into the at least one ultimate remote volume,

redirecting to the ultimate local auxiliary volume of updates addressed to the selected data object,

permitting use of the selected data object during mirroring in associative operation with the ultimate resulting source volume,

synchronizing the penultimate local auxiliary volume into the selected data object,

synchronizing the at least one ultimate remote volume into the penultimate remote volume, and

repeating a next mirroring cycle by default command after completion of copy to the at least one second storage device, unless receiving command for mirroring break.

It is yet a further object of the present invention to provide a method and a system for:

storing in the at least one remote storage device of a complete mirrored copy of the selected data object comprising updates entered thereto at the time when copy of the before to penultimate local auxiliary volume was completed.

It is yet a further object of the present invention to provide a method and a system for:

repeating operation of the mirroring functionality at discrete repetition intervals of time defined as lasting at least as long as duration of copying of the ultimate local auxiliary volume to the ultimate remote volume,

synchronizing updates to overwrite the selected data object, and

synchronizing a later remote volume to overwrite the penultimate resulting first remote volume.

### BRIEF DESCRIPTION OF THE DRAWINGS

In order to better describe the present invention and to show how the same can be carried out in practice, reference will now be made to the accompanying drawings, in which:

FIG. 1 is an example of a network connectivity,

FIG. 2 presents the freeze procedure,

FIG. 3 is a flowchart for sorting between various types of I/O READ and I/O WRITE instructions,

FIG. 4 illustrates the procedure for an I/O READ instruction addressed to the source volume SV after start of the freeze procedure,

FIG. 5 shows steps for the processing of an I/O WRITE command containing data updated after the freeze command,

FIG. 6 exhibits the steps for an I/O WRITE instruction, for data unaltered since freeze time,

FIG. 7 provides a general overview of the mechanisms of the mirroring functionality, and

FIG. 8 illustrates detailed consecutive steps of the mirroring functionality.

### DISCLOSURE OF THE INVENTION

The present invention achieves mirroring, or replication, of a selected data object from a local storage device, to a remote storage device, by sequential freeze and copy of discrete blocks of data. During mirroring, the selected data object may be used uninterruptedly, since mirroring is transparent to the operating system. Copying of the successive discrete blocks of data is performed asynchronously and in the background.

Mirroring consists of a succession of freeze and copy procedures repeated sequentially in successive mirroring cycles. Only the last local updated mirrored version is saved in the remote storage device. Each new updated version overwrites the previous version. An updated version existing when mirroring starts with a first mirroring cycle s=1, is safely stored after two more mirroring cycles, when s=3.

The terms used in the description are easily related to a storage area network (SAN) supporting virtualization. A virtual volume of such a virtualized SAN may contain a group of data object, a plurality of local storage devices, and a plurality of remote storage devices. However, for ease of understanding of the method, one may consider a system with only one data object, one local storage device, and one remote storage device.

When the mirroring functionality is operated, a selected data object is frozen by a freeze procedure, for example as a source volume. Simultaneously, a first local auxiliary volume is created in the local storage device and a first remote volume, of the same size as the frozen source volume, is created in the remote storage device. Since the source volume is and must remain frozen, it may not incur changes, but it may be copied by the copy procedure to the remote storage device.

The selected data object may be used during mirroring. At freeze time, the Operating System O.S. creates a resulting source volume comprising both the frozen selected data object and the first local auxiliary volume. The resulting source volume is accessible to the I/O Read and I/O Write operations. Evidently, only read operations are permitted to the frozen source volume, while the write updates to the selected data object are redirected to the first local auxiliary volume.

Once the frozen source volume is mirrored to the remote storage device, the freeze and copy procedures are repeated. The first local auxiliary volume in the resulting source volume is now frozen, and simultaneously, a second local auxiliary volume and a second remote volume are created. The second local auxiliary volume is added to the previously created resulting source volume, to form a new resulting source volume for use by the Operating System O.S. In turn, the frozen first local auxiliary volume is copied to the second remote volume. Likewise, the data object may be used with the previous resulting source volume to which the last frozen local auxiliary volume is added to form a last resulting source volume. In principle, the mirroring functionality performs successive freeze and copy procedures to replicate one, or a group of data object(s), from one or more local storage device(s), to one or more other, or remote, storage device(s). A singular case relates to the mirroring of a selected data object consisting of only a single data object, residing in one local storage device, to but one remote storage device.

The mirroring functionality is operable to perform more than one mirroring operation simultaneously. For example, two different data objects, each one residing in say, a different volume in a different local storage device, are possibly mirrored to two different remote storage devices. Evidently, simultaneous mirroring is not limited to two selected data objects.

The mirroring functionality is also capable of cross mirroring, which in parallel to the last example, results to mirroring two different data objects, one residing in the local storage device and the other in the remote storage device, for mirroring, correspondingly, to the remote storage device and to the local storage device. Cross mirroring is not restricted to simultaneous mirroring of two selected data objects.

In general, the mirroring functionality achieves mirroring of groups of data objects, from several local storage devices to several remote storage devices, as well as two directional cross mirroring. A mirroring overview table presents mirroring options I to VI inclusive, for direct mirroring, to which cross-mirroring must be added for all the options I to VI.

Mirroring Overview Table

| | MIRROR | FROM | TO |
|---|---|---|---|
| | # of Data Objects | Local Storage Devices | Remote Storage Devices |
| I | 1 | ‘ 1 | 1 |
| II | 1 | 1 | >1 |
| III | >1 | 1 | 1 |
| IV | >1 | >1 | 1 |
| V | >1 | 1 | >1 |
| VI | >1 | >1 | >1 |

Modes for Carrying Out the Invention

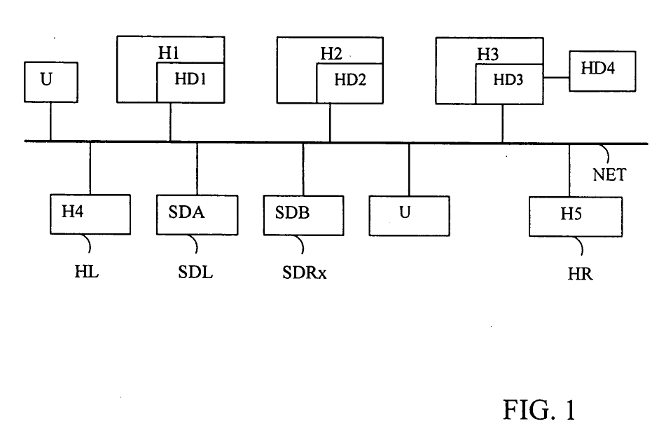

Reference is made to FIG. 1 of the co-pending patent application PCT/IL00/00309, entitled “Storage Virtualization in a Storage Network”, by the same applicant, incorporated herewith by reference in whole, cited below as the '309 patent. Reference is also made to FIG. 1 in the present application, depicting a network connectivity NET. There are coupled to the network connectivity NET a plurality of users U, computing facilities such as hosts, or servers H, or processors, and storage devices SD, such as Hard Disks HD. Under the control of a first, or local processing facility, mirroring may take place from one local storage device to another remote storage device controlled by a second, or remote processing facility. For example, a host H4 may command mirroring from a storage device SDA to a storage device SDB, controlled by another processing facility H3. Also, the host HI may control mirroring from a first hard disk HD1 to a second hard disk HD2 coupled to a processor H2. In the same manner, the host H2 may command mirroring from a first hard disk HD2 to a second hard disk HD3 or another hard disk HD4. Mirroring of a selected data object residing in more than one storage devices may be effected to one or more storage devices. The minimum requirements are for two processing facilities and for at least two storage devices on the network connectivity: one local storage device for copying from and one remote storage device for writing thereto.

As stated above, the mirroring of a data object from one storage device to another storage device requires the application of successive freeze and copy procedures. However, the operation of a network connectivity may not be hampered while mirroring. Therefore, the description below illustrates first the freeze procedure, then the operation of the system while the freeze procedure is running and last, the copy procedure.

The Freeze Procedure

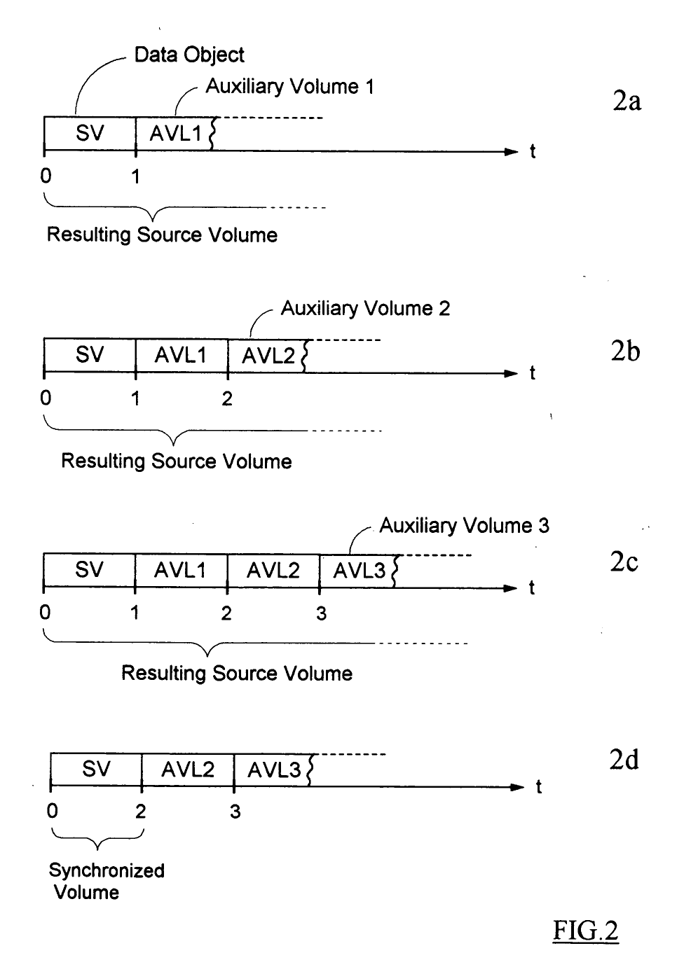

A graphical illustration of the freeze procedure is depicted in FIG. 2, in stages from 2a to 2d. The horizontal axis t refers to time, starting with t=0.

It is assumed that the mirroring functionality operates on at least two processing facilities, such as a first and a second processing facility, respectively HL and HR, coupled to a network connectivity NET. A first storage device SDL and at least one second storage device SDRx, where x identifies the specific storage device, referred to as, respectively, the local storage device and the at least one remote storage device, as are also coupled to the network connectivity NET. The at least one remote storage device SDRx may thus consist of a first remote storage device SDR1, a second remote storage device (SDR2) and so on.

The designations local and remote are used for origin and destination, without implying any restriction on the physical location of the storage devices. Thus, both the local and the remote storage devices may reside, say, inside the same or in different storage device(s) coupled to a SAN, or to a host H, the different storage devices being adjacent or each one on opposite side of the globe. Copy is made from the local storage device to one or more remote storage device(s). Any storage device may be designated with either name, but there is only one local storage device when mirroring therefrom.

To start, the mirroring functionality, which contains both the freeze procedure and the copy procedure, receives indication of the data object selected to be frozen. As illustrated at stage 2a of FIG. 2, at a given moment, at time t=1, the freeze procedure receives a request to freeze a selected data object as a source volume SV. In consequence, the “frozen” source volume SV is thus restricted to “read only”, which does not alter the contents of the source volume. The frozen source volume SV may now be copied as will be described below.

Use of the data object is enabled while keeping the mirroring functionality transparent to the O.S. Simultaneously with the freeze of the source volume SV at time t=1, the freeze procedure also creates a first auxiliary, perhaps virtual, local volume, indicated as local auxiliary volume 1 or AVL1. Together, the frozen source volume SV and the local auxiliary volume 1 form a Resulting Source Volume. From the point of view of the Operating System O.S., the resulting source volume is seen as the original selected data object with which is used transparently.

In turn, from the moment the source volume SV is frozen, WRITE operations directed by the local processing facility HL to the that frozen source volume are redirected by the mirroring functionality to the local auxiliary volume 1 AVL1 residing in the resulting source volume. Read operations are thus permitted as long as they concern an original unaltered portion of the contents of the frozen source volume SV. Write operations to the frozen source volume SV are redirected to the local auxiliary volume 1, since otherwise, they would effect changes to the contents of the frozen source volume SV. The mirroring functionality, and thus the freeze procedure, resides in both local and remote processing facilities, and is enabled to intercept I/O commands directed to the frozen data object, as will be described below with respect to the operation of the system. WRITE operations diverted to the local auxiliary volume 1 AVL1 are defined as updates. It is noted that a local auxiliary volume remains operative from time of creation until the time a next freeze is taken. In other words: until a next local auxiliary volume is created. Furthermore, the performance of the processing facilities involved is only but slightly affected by the freeze functionality that deals only with routing instructions, i.e. the redirection of I/O READ or I/O WRITE instructions.

Referring to stage 2b of FIG. 2, at time t=2, after the frozen source volume SV is copied, a next freeze is performed and applied to the local auxiliary volume 1 AVL1. Simultaneously, a new local auxiliary volume 2 AVL2 is created, in the same manner as described for the local auxiliary volume 1 AVL1. In parallel, a new resulting source volume is now made to comprise the previous resulting source volume with the addition of the local auxiliary volume 2 AVL2. The updates contained in the frozen local auxiliary volume 1 AVL1 may now be copied, as will be described below. Again, the O.S. considers the last resulting source volume as the original source volume since the freeze operation is transparent.

At stage 2c of FIG. 2, after the frozen local auxiliary volume 1 AVL1 is copied, the local auxiliary volume 2 AVL2 is frozen at time t=3, and an local auxiliary volume 3 AVL is created. The updates previously written into the frozen local auxiliary volume 2 AVL2 may now be copied. As before, the last created, or ultimate local auxiliary volume 3 AVL3, becomes part of the new and ultimate resulting source volume, together with the previous resulting source volume.

The third resulting source volume thus consists of the first source volume SV as frozen at time t=1, of the frozen local auxiliary volumes 1 and 2 respectively AVL1 and AVL2, and of the ultimate local auxiliary volume 3 AVL3. Taking advantage of the fact that at time t=3 both the first frozen source volume SV and the frozen local auxiliary volume 1 AVL1 have already been copied by mirroring, these last two volumes may now be synchronized. Stage 2d of FIG. 2 reflects this last step, at time t=3, whereby the updates contained in the local auxiliary volume 1 AVL1 are synchronized into the first frozen source volume SV. The local auxiliary volume 1 AVL1 is deleted, and thereby, storage space is saved, while the contents of the ultimate resulting source volume are kept unchanged. The mirroring functionality which operates the freeze procedure is now allowed to continue to operate, or is interrupted at will.

When mirroring is commanded to continue, then, at time t=4, although not shown in FIG. 2, after copy of the local auxiliary volume 2 AVL2 is completed, a new local auxiliary volume will be opened to become the ultimate local auxiliary volume. Simultaneously, copy of the penultimate local auxiliary volume AVL, in this case the local auxiliary volume 3 AVL3, will be started. At the same time, the updates residing in the before-penultimate local auxiliary volume AVL, here the local auxiliary volume 2 AVL2, will be synchronized into the first frozen source volume SV. The local auxiliary volume 2 AVL2 may now be deleted. Evidently, use of the data object is permitted to continue, in association with the ultimate resulting source volume consisting of the last resulting source volume and of the ultimate local auxiliary volume.

Data Structure of a Freeze

When a freeze of a source volume SV is ordered at time t=1, the now frozen source volume is arbitrarily divided into sequentially numbered segments or chunks of 1 MB for example, and these chunks are listed in a Freeze Table 1 created at freeze time within the local auxiliary volume 1 AVL1. The total number of entries in the freeze table 1 is thus equal to the capacity of the frozen source volume SV, expressed in MB. If the division does not yield an integer, then the number of chunks listed in the freeze table is rounded up to the next integer. The freeze table 1 resides in the local auxiliary volume 1 and is a tool for redirecting I/O instructions directed by the O.S. to the data object

Starting with the freeze command at t=1, all the I/O WRITE instruction updates directed to the data object, are routed to the local auxiliary volume 1. The I/O READ commands are separated into two categories. A first category of READ instructions relates to data which were not amended since the beginning of the freeze at t=1, and reside unaltered in the source volume SV. A second category of READ instructions refers to data that underwent update by WRITE commands, which updates occurred after the freeze, and therefore, were routed to the local auxiliary volume 1.

To relate between the frozen source volume SV and the local auxiliary volume 1, a mapping table is required. For example, when the O.S. commands an I/O READ instruction on data that was updated after a freeze, the address of that data in the local auxiliary volume is needed.

TABLE 1
Freeze

| Chunk No. | Address |
|---|---|
| 0 | −1 |
| 1 | −1 |
| 2 | 13 |
| 3 | −1 |
| . . . | . . . |
| n-x | 17 |
| . . . | |
| Last | −1 |

With reference to Freeze Table 1, there is shown a first left column with chunk numbers of the source volume SV and a second right column with an index pointing to the address where each chunk is mapped. The chunk number 0 in the first line and left column of the Freeze Table 1 is indexed as −1 in the right column of that same first line.

By convention, the index −1 indicates original condition or lack of change since the last freeze. Thus, the chunk in question, here chunk 0, was not updated since the freeze time t=1 and the related data is therefore found in the source volume SV. Any index number other than −1, thus greater or equal to zero, indicates the address and the fact that the so numbered specific chunk was updated after the freeze time t=1. The indices other than −1, redirect the I/O instructions to a specific address to be found in the ultimate local auxiliary volume.

It is noted that the mechanism for routing I/O instructions to the frozen source volume SV and to the local auxiliary volume permits continuous unhampered use of the data object.

Freeze Procedure

The freeze procedure routes I/O instructions directed to the data object according to three different conditions. To keep the terms of the description simple, reference is made to only the first freeze, thus to one frozen source volume SV and to one first local auxiliary volume.

1. READ instructions are directed either to the source volume SV, if unaltered since freeze, or else, to the local auxiliary volume.

2. WRITE instructions for a chunk updated after freeze start at t=1, are directed to the local auxiliary volume.

3. WRITE instructions to a chunk of unaltered data residing in the source volume SV require copy of that chunk to the local auxiliary volume, and only then, writing thereto in the local auxiliary volume.

I/O Instructions Parsing

The sequences for parsing the I/O instructions according to the three above-mentioned conditions are described below.

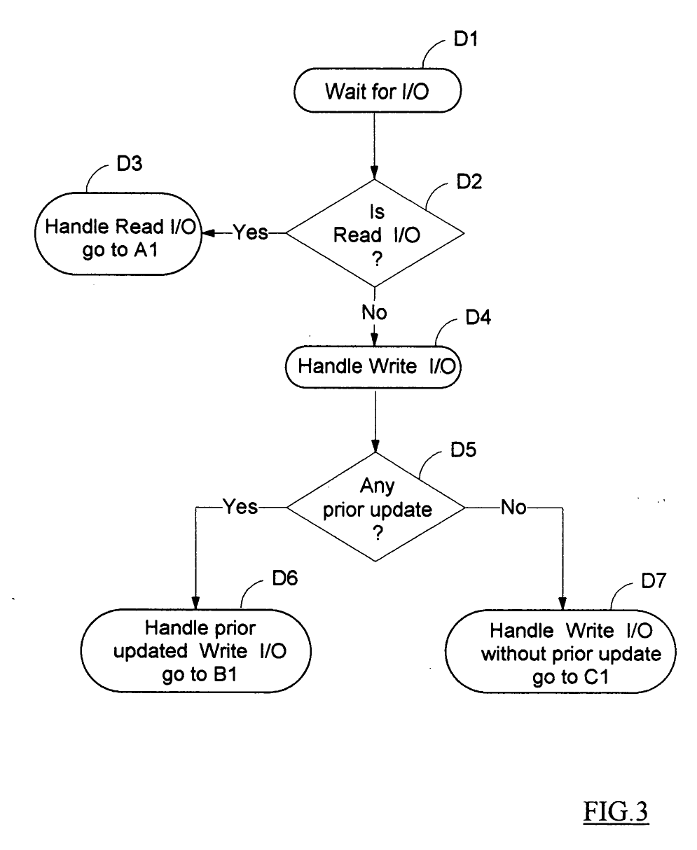

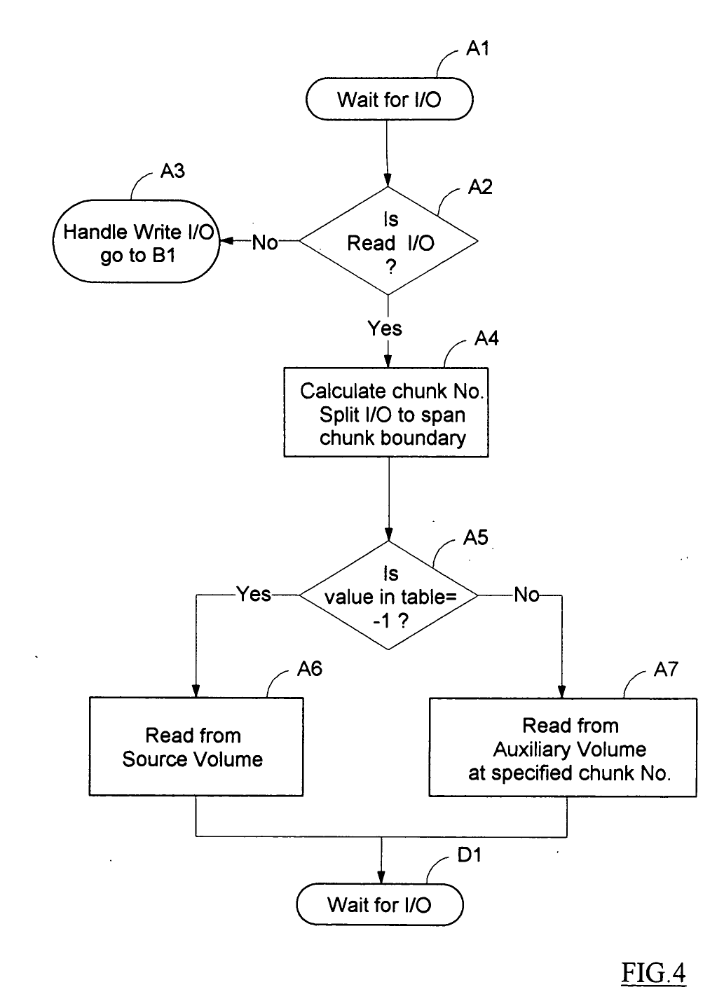

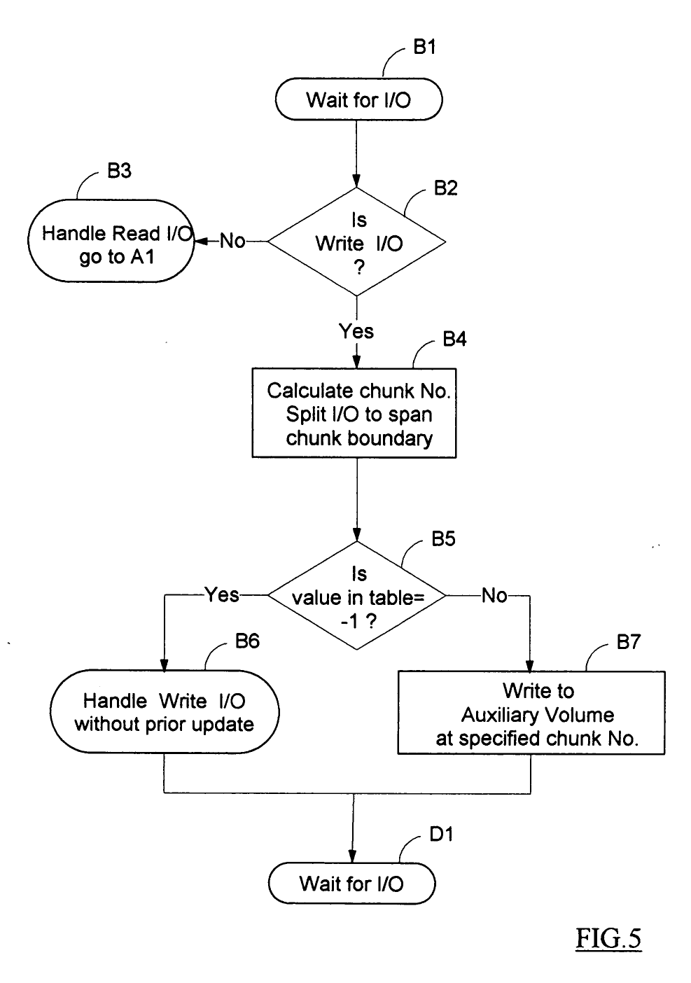

Referring to FIG. 3, the O.S. waits for an I/O instruction in step D1, and when such an instruction is received, a test at step D2, differentiates between READ and WRITE instructions. For a READ instruction, thus for yes (Y), control is diverted to step D3, for further handling, as by step A1 in FIG. 4, described below. In case of no (N) for a WRITE instruction, control passes via step D4 handling Write I/O instructions, to step D5, to check if there were prior updates or if this is the first WRITE after freeze. If there were prior updates, then control passes to step D6 to be handled by step B1 in FIG. 5, to be explained below. In case there was no prior update, then the flow of control proceeds to step D7, which passes I/O WRITE instructions without prior update to step C1 below.

Read Instructions

FIG. 4 illustrates the procedure for an I/O READ instruction sent to the data object after freeze start. The instruction received by the “Wait for I/O” first step A1 passes to step A2, where it is filtered in search of a READ instruction. In the negative (N), the WRITE instruction is diverted to step A3 for passage to step B1 in FIG. 5. In the positive, for yes (Y), the READ command is sent to step A4.

If the frozen source volume SV was divided in chunks of 1 MB, step A4 calculates the chunk number and searches for the index in the freeze table. The chunk number is calculated by an integer division of the address number by 1 MB, and further divided by 512 to find the sector number. Thus, 1 MB/512=(1024 bytes×1024 bytes)/512. The result is forwarded to the following step A5. Sometimes, when the data spans over the boundaries of a chunk, more than one chunk number is provided, as pointed out by the information found in the address, which always indicates a start location and the length of the I/O instruction. The O.S. then searches for the address(es) in the Freeze Table 1, across the calculated chunk number(s).

Step A5 differentiates between the index −1 designating data unaltered since freeze, and other indices. Zero and positive integer values indicate that the data reside in the local auxiliary volume.

If the chunk number forwarded to step A5 is −1, then the READ command is sent to the step A6, to “Read from the source volume”. Else, the READ command is directed to the address in the local auxiliary volume, as found in the Freeze Table 1, as per step A7. After completion, both steps A6 and A7 return control to the first step D1 in FIG. 3.

Write Instructions

FIG. 5 shows steps for the processing of an I/O WRITE command to a chunk of the local auxiliary volume, which contains data updated after the freeze command.

In the first step B1, the procedure waits to receive an I/O command that is then forwarded to the next step B2. A filter at B2, checks whether the I/O command is a READ or a WRITE command. An I/O READ command is routed to step B3 to be handled as an I/O READ command by step A1 in FIG. 4, but an I/O WRITE command is directed to step B4, where the chunk number is calculated by division, as explained above, for access to the Freeze Table 1. Should the WRITE command span more than one single chunk and cross chunk boundaries, then two or more chunk numbers are derived.

The one or more chunk number is passed to step B5 where the freeze table 1 is looked up to find the index number corresponding to the chunk(s) in question. If a value of −1 is found, then control is directed to step B6, to be handled as unaltered data residing in the source volume SV. In case a zero or positive index value is discovered in the Freeze Table 1, then by step B7, instructions are directed to the local auxiliary volume, for writing to the specified address. From steps B6 and B7, control returns to the I/O waiting step D1 in FIG. 3.

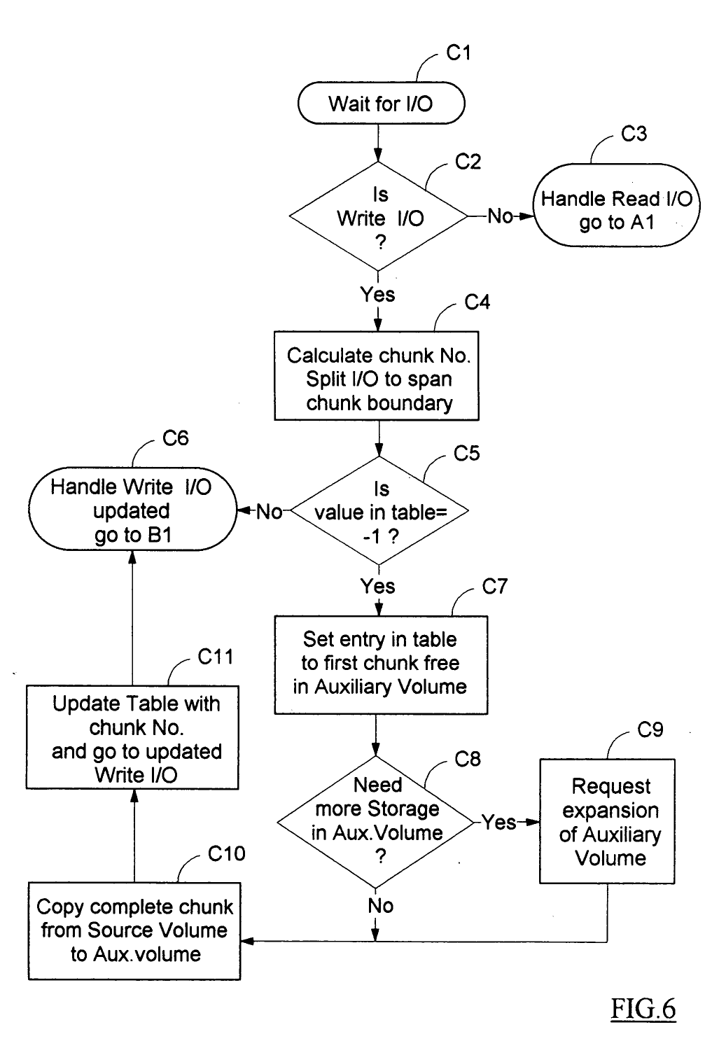

FIG. 6 exhibits the steps for an I/O WRITE instruction, for data unaltered since freeze time t=1. The first step C1 is a “Wait for I/O” instruction that once received, leads to step C2 acting as a “Write I/O” filter. If the received I/O instruction is not a “Write I/O”, then control is passed to step C3 to be handled as a “Read I/O” as by step A1 in FIG. 4. Otherwise, for a write instruction, the chunk number is calculated in step C4. I/O commands crossing the boundary of a chunk are also dealt with, resulting in at least two chunk numbers.

In turn, step C5 uses the calculated chunk number to search the freeze table and differentiate between unaltered data and updated data. In the latter case, control passes to step C6, where the I/O is directed for handling as a previously updated Write I/O command by step B1 in FIG. 5.

For unaltered data, control flows to step C7. However, before writing data to the auxiliary volume, to a chunk to be updated for the first time since freeze, a free memory location must be found. Therefore, in step C7, a search is made for a first free chunk in the local auxiliary volume. When found, the index opposite the chunk number calculated in step C4 is altered, to indicate not −1 anymore, but the address in the local auxiliary volume. In practice, the single or more chunks must first be copied from the source volume SV to the local auxiliary volume and only then, overwritten for update by the WRITE instruction.

Control next passes from step C7 to step C8, where a check is performed to find out whether there is need for more storage space in the local auxiliary volume. For more storage space in a SAN supporting virtualization, the request is forwarded to a virtual appliance. According to the disclosure of the '309 patent, a request is forwarded to the virtualization appliance to grant storage space expansion to the local auxiliary volume, as in step C9. For other environments, a storage allocation program run by the O.S. of the local host HL handles additional storage space.

According to the case, control passes from either step C8, not requesting additional storage space, or from step C9 after expansion of storage space, to step C10, where the complete chunk is copied from the source volume SV to the local auxiliary volume. Once this is completed, control passes to step C11.

In the last step, C11, the freeze table 1 is updated and opposite the chunk number calculated in step C4, instead of the value −1, the address in the local auxiliary volume is entered. From step C11 control returns to step B1 in FIG. 5, via step C6.

It is noted that the local auxiliary volume has at most, the same number of chunks as the source volume SV. This last case happens when all the chunks, or segments, of the source volume SV are written to. I/O WRITE instruction updates to the same chunk of the source volume SV overwrite previous WRITE commands that are then lost.

The Copy Procedure

Referring to the description related to the freezing of a source volume SV, at stage 2a in FIG. 2, it was stated that the source volume was copied after the freeze took place. The mirroring functionality may thus command to copy the frozen source volume SV, from the storage device of origin wherein it resides, defined as a local storage device, to any other storage device, which is referred to as a remote storage device. The remote storage device is possibly another storage device at the same site, or at a remote site, or consists of many remote storage devices at a plurality of sites. The remote storage device may even be selected as the same storage device where the source volume SV is saved.

The mirroring functionality may be repeated sequentially, or may be stopped after any freeze and copy cycle.

Copying from the frozen source volume SV to the remote storage device does not impose a load the processing facility resources, or slow down communications, or otherwise interfere with the operation of the processing facility, since only freeze and copy procedures are required.

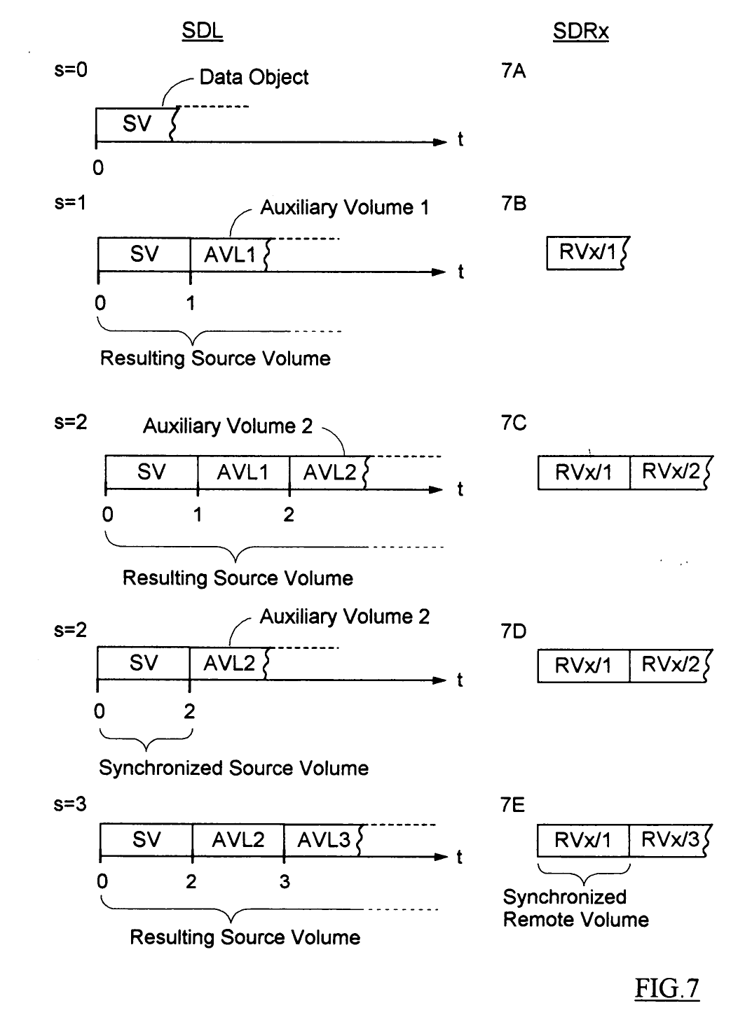

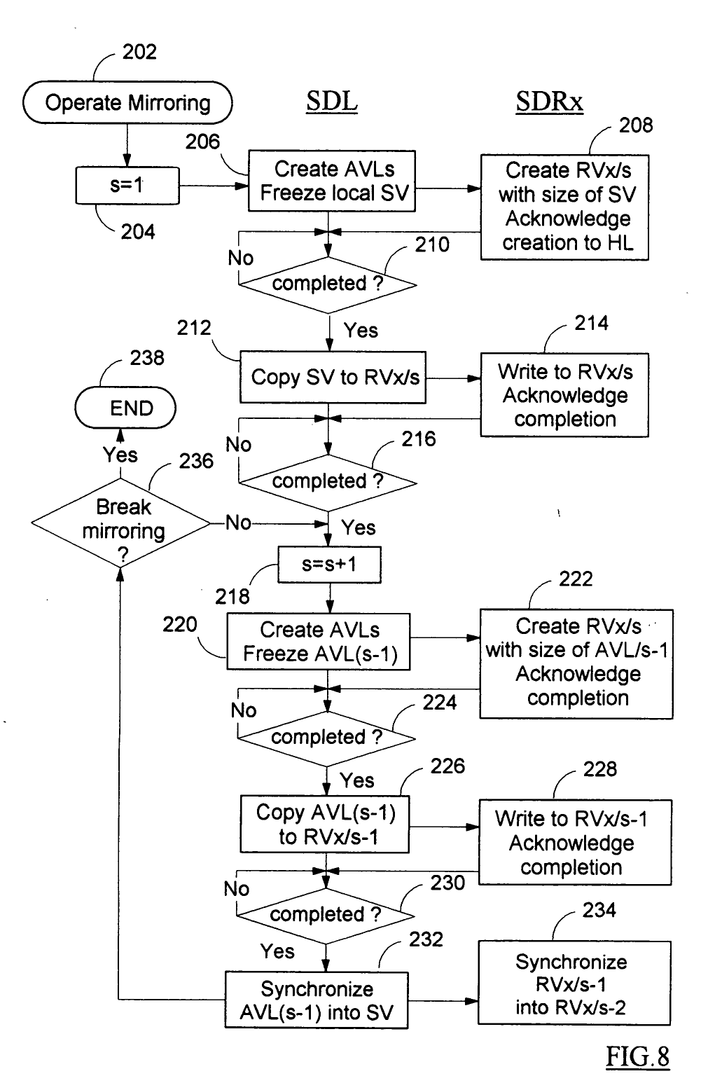

An illustration of the mechanisms of the mirroring functionality is presented in FIG. 7 as a general overview, while a more detailed description is provided with reference to FIG. 8.

In FIG. 7 the left column relates to the local storage device SDL wherein a data object resides in the source volume SV, and the abscise displays a time axis t. The right column indicates events occurring in parallel to those at the local storage device, and depicts the process at the remote storage device SDRx, where x[1, 2, . . . , n] is chosen out of the at least one x available storage device. The denomination “the remote storage device SDRx” is used below in the sense of at least one storage device.

Stage 7A in FIG. 7 shows the situation prior to mirroring. In the left column, the source volume SV created at time t=0 contains the data object, while a mirroring cycle counter s is at zero. There are no events in the right column.

At stage 7B, in the left column, the mirroring counter is increased by one to s=1 and a freeze of the source volume SV is commanded at time t=1. At the same time, a first local auxiliary volume 1 AVL1 is created in the local storage device SDL, whereto updates to the data object are now directed. The updates are those I/O WRITE instructions from the computing facility HL that are redirected to the local auxiliary volume.

Simultaneously with the freeze at t=1, a first remote volume RVx/s, here RVx/1, is created in the remote storage device SDRx, in the right column of FIG. 7, with the same size as the source volume SV. In turn, the frozen source volume SV is copied, in the background, and written to the remote volume RVx/1.

It was stated above that the freeze procedure divides a frozen data object into chunks of e.g. 1 MB. Upon creation of a local auxiliary volume and of the resulting source volume, a freeze table is also created therein, to relate between the source volume and the updates. The freeze table redirects I/O instructions from the data object to the local auxiliary volume, when necessary.

Meanwhile, the O.S. remains in operative association with both the source volume SV and the first local auxiliary volume AVL1, forming together the resulting source volume. It is noted that mirroring is executed in the background without need to wait for I/O instructions from the remote storage device. Thereby, the speed of operation of the local processor HL or of the network facility is not impaired.

At stage 7C of FIG. 7, the mirroring counter is increased by one to s=2 and a second freeze command is received at time t=2, occurring at or after completion of the copy operation of the source volume SV to the first remote volume RVx/1. Simultaneously, the first local auxiliary volume AVL1 is frozen and a second remote volume RVx/2 is created in the remote storage device SDRx, in the right column, with the same size as the first local auxiliary volume AVL1. A second local auxiliary volume 2 AVL2 is created in the local storage device SDL whereto updates to the data object are directed.

A freeze table is automatically created by the freeze procedure, to reside in each local auxiliary volume, to the advantage of the O.S. In turn, the first local auxiliary volume AVL1, including the freeze tables for the benefit of the second computing facility HR, is copied to and written to the second remote volume RVx/2.

At the same time, a new resulting source volume is created together with a new freeze table. The new resulting source volume consists of the previous resulting source volume to which is added the second local auxiliary volume AVL2. The O.S may thus communicate with the new resulting source volume to use the data object in parallel to mirroring.

At time t=2 in the left column of stage 7C, the local storage device SDL contains the source volume SV, the first local auxiliary volume AVL1 and the second local auxiliary volume AVL2. At the same time in the right column, the remote storage device SDRx contains the first and the second remote volumes.

Still with the mirroring counter at s=2, but at stage 7D, the frozen volumes, namely the source volume SV and the first local auxiliary volume are synchronized, whereby the updates previously written into the first local auxiliary volume AVL1 are entered into the source volume SV. The freeze table residing in the first local auxiliary volume AVL1 is used for correctly synchronizing the updates. The first local auxiliary volume AVL1, which contains at most as many chunks or segments as the source volume SV, is copied to overwrite the contents of the source volume SV that retains its original size. The first local auxiliary volume AVL1 is now deleted.

The indices opposite the chunk numbers in the freeze table residing in the second local auxiliary volume AVL2 are set to index values of −1, to reflect the status of the synchronized volumes. In parallel, the second remote volume RVx/2 is synchronized into the first volume RVx/1, which retains the same size as the source volume SV. Synchronization at the remote storage device is performed by the second processing facility HR using the freeze table copied thereto together with the last copied local auxiliary volume. The second remote volume RVx/2 may now be deleted.

Synchronization limits the required storage space in both the local storage device SDL and the remote storage device SDRx, by deleting the local auxiliary volume and the remote volume that now becomes unnecessary.

Stage 7E is another freeze stage, equivalent to stages 7B and 7C. The mirroring cycle counter at the first computing facility HL is increased by one to s=3, and a freeze of the second local auxiliary volume AVL2 is executed at time t=3. In addition, a third local auxiliary volume AVL3 is created with the local storage device SDL. Simultaneously, a third remote volume RVx/3 is created in the remote storage device SDRx, in the right column, with the same size as the second auxiliary volume AVL2. The ultimate resulting source volume now contains the previous resulting source volume plus the ultimate local auxiliary volume AVL3.

As before, the last frozen local auxiliary volume, here AVL2, is copied to the last created remote volume, RVx/3. After copy completion is acknowledged to the first computing facility HL, command is given to synchronize the last frozen local auxiliary volume AVL2 with the source volume SV.

In the remote storage device SDRx, the second remote volume RVx/2 is synchronized with the first remote volume, RVx/1, under control of the second computing facility HR. It is noted that at this third mirroring cycle for s=3, the remote storage device SDRx now contains a copy of the resulting source volume that existed in the first mirroring cycle, at s=1. At a mirroring cycle of s=T, the copy saved in the remote storage device SDRx is always that of the resulting source volume at time s=T−2. At all times, there is a lag of two mirroring cycles between the last held copy at the remote storage device and the ultimate resulting source volume in the local storage device SDL.

Next, the process continues in the same manner as described above.

It is noted that the denomination remote storage device x, SDRx, is a name used to refer to a storage device different from the local storage device, at the same site or at a remote site. Thus, mirroring from a source volume SV residing in a local SANL at a local site, is feasible not only to a storage device at the local site, but also to a storage device emplaced at a remote site, using the same mirroring procedure. Likewise, cross mirroring is feasible, as well as simultaneous cross mirroring.

Mirroring Flow of Control

FIG. 8 illustrates the consecutive steps of the mirroring functionality, applicable to any network connectivity. For a Storage Area Network, or SAN, and with reference to the SAN virtualization facility of the '309 application, the SAN consists of at least: a local host HL, a remote host HR and two separate storage devices, local and remote, all referred to but not shown in FIG. 8. The same minimum of one local host HL and one remote host HR, and two storage devices is necessary for other network connectivities. As above, to differentiate between the two storage devices, these are designated as the local storage device SDL and the remote storage device SDRx. The names given to the storage devices are unrelated to their location.

In step 202 of FIG. 8, command is given to mirror a selected source volume SV, which resides in a local storage device SDL that is coupled to a local host HL. The command is entered by a user, or by a System Administrator, or by the Operating System O.S., or by a software command, none of which appears in FIG. 8. Mirroring is directed to one or more storage devices referred to as remote storage device x, SDRx, where x is an integer, from 1 to n. Control passes first to step 204, where a mirroring cycle counter s is set to s=1, and continues to step 206.

Step 206 applies the freeze procedure to create a resulting source volume consisting of the frozen source volume SV and a newly created first local auxiliary (virtual) volume AVL/s, at mirroring cycle s=1, in the local storage device SDL. In parallel, control passes to step 208, which commands the creation, in the remote storage device x SDRx, of a first remote virtual volume RVx/s, here RVx/1, with the same size as that of the source volume SV. In the case of a SAN, the creation and management of virtual volumes, referred to as volumes for short, is transparent to the O.S, and the storage of data in physical storage devices, is handled as explained in the co-pending '309 application. For other non-virtualized environments, use is made of a storage allocation program run by the local host HL.

Control now passes to step 210, which checks for an acknowledgment of completion from step 208, to ensure the availability of the first remote volume RVx/s. If the check is negative, a new check loop through step 210 is started. Otherwise, in step 212, for a positive reply to the test of step 210, a command starts the copy of the source volume SV to the first remote (virtual) volume RVx/s, and control flows to step 214.

By step 214, complementary to step 212, the source volume SV is written to the first remote volume RVx/1, and when ended, completion is acknowledged to the computing facility HL, which then performs a completion check in step 216, similarly to step 210. As before, a negative response causes a loop-again through the completion check at step 216, while a positive answer passes command to step 218, where the mirroring cycle counter is increased by one, to s=s+1, here s=2.

Control is now forwarded to step 220, to continue mirroring. In the local storage device SDL there is created first an ultimate local auxiliary volume designated as AVL/s, which for s=2, is the second local auxiliary volume AVL2, and then, the penultimate local auxiliary volume AVL/s−1, here AVL1, is frozen. There is also created an ultimate resulting source volume, in the manner described above.

Control now passes to the remote storage device SDRx, to step 222 where a second remote volume, referred to as RVx/s, here RVx/2, is created with the same size as the penultimate local auxiliary volume AVL1, designated here as AVL/s−1. An acknowledgement of completion is sent to step 224.

When acknowledgment of the creation of second remote virtual volume RVx/s is received by the completion-check of step 224, control is passed to step 226, but else, the completion-check is repeated.

In step 226 command is given to copy the frozen penultimate, here the first, local auxiliary volume AVL/s−1 to the ultimate, here the second, remote volume RVx/s. Step 228 executes the write operation from the first local auxiliary volume AVL/s−1 to the second remote volume RVx/s, which upon write completion, is acknowledged to step 230.

It is noted that at this stage, both the source volume SV and the first local auxiliary volume AVL1 are acknowledged as being actually mirrored to the SDRx, in both the RVx/1 and the AVRx/2. Meanwhile, the second freeze is operating at the local host HL and the new updates are redirected to the local auxiliary virtual volume AVL2 Practically, there is no further reason to separately operate either the first local auxiliary volume AVL1 or the second remote volume RVx/2, and therefore, those (virtual) volumes may be synchronized with, respectively, the source volume SV and the first remote virtual volume RVx/1. Such synchronization and unification is performed, respectively, in steps 232 and 234, whereby only the source volume SV and the first remote virtual volume RVx/1 remain available, while both the first local auxiliary virtual volume AVL1 and the second remote volume RVx/2 are deleted. If so wished, the mirroring loop is commanded to be broken in step 236 and ended in step 238, or else, mirroring is continued by transfer of control to step 218.

If the mirroring loop is not broken, then control returns to step 218, where the mirroring counter is increased again by 1, to s=3. The procedure repeats a loop through the steps from 218 to 236 inclusive, which either continues mirroring or else, ends mirroring if so commanded.

The above described method is implemented for possible combinations of one single or a plurality of data objects, mirrored from one or from a plurality of storage devices, into one or a plurality of remote storage devices. Table 2 below presents the different possibilities and some insight as to the local auxiliary volumes and to the remote volumes.

TABLE 2

| | | | Created Local | | Maximum # of |
|---|---|---|---|---|---|
| | | FROM | Auxiliary | TO | Created Remote |
| | MIRROR | Local | Volumes Per | Remote | Volumes Per |
| | Data | Storage | mirroring Cycle | Storage | mirroring Cycle |
| | Objects | Devices | = | Devices | = |
| I | 1 | 1 | 1 | 1 | 1 |
| II | 1 | 1 | 1 | >1 | # of Remote |
| | | | | | Storage Devices |
| III | >1 | 1 | Data Objects | 1 | # of Data Objects |
| IV | >1 | >1 | Data of Objects | 1 | # Data of Objects |
| | | | or # of Local | | or # of Local |
| | | | Storage Devices | | Storage Devices |
| V | >1 | 1 | Data Objects | >1 | # of Data Objects |
| | | | | | or # of Remote |
| | | | | | Storage Devices |
| VI | >1 | >1 | Data Objects or # | >1 | # of Data Objects |
| | | | of Local Storage | | or # of Local |
| | | | Devices | | Storage Devices |

The mirroring functionality described above is represented by row I in Table 2. This is the simplest and basic mirroring method implementation for mirroring one data object, from one local storage device to one remote storage device. For each mirroring cycle, one local auxiliary volume AVL and one remote volume RVx are created.

For example, in row II, one data object is stored in one local storage device SDL, for mirroring into a plurality of remote storage devices SDRx, where x receives the identity of the specific storage device, will require the creation of a number of remote volumes equal to the number of the plurality of remote storage devices, for each mirroring cycle. Thus, if mirroring is requested for four remote storage devices, SDR1 to SDR4, then the mirroring functionality will apply the freeze procedure, as by row I, and next, the copy procedure will be operated in parallel four times, once for each remote storage device. The next mirroring cycle, thus the interval between two consecutive mirroring cycles, will be started after completion of the copy to, and writing to all the four storage devices. Each mirroring cycle will require one local auxiliary volume and four remote volumes RVx, with x ranging from 1 to 4, for example. The minimal number of local auxiliary volumes and of remote volumes created for each mirroring cycle by the mirroring functionality is shown in the third and last column of Table 2. Evidently, the number of remote storage devices may be multiplied by integers. Thereby, mirroring may be achieved to 8, 12, 16, etc. remote storage devices.

Row III of Table 2 calls for the mirroring of a selected data object residing in local storage SDL as single data objects, thus as a group of data objects, into one remote storage device SDRx. The mirroring functionality is applied as by row I, by freezing all the single data objects simultaneously. For example, if the selected data object is a group of three single data objects, then these three are frozen at the same time, and then each one is copied to the remote storage device SDRx. The next mirroring cycle may now start after completion of writing to the storage device SDRx.

Row IV presents the issue of mirroring a selected data object consisting of e.g. three single data objects residing in three different local volumes SDLi, with i=1, 2, and 3, to one remote storage device SDRx. Again, the freeze procedure is simultaneous for the three single data objects and the method of row I is applied to each one of the three single data objects. A next mirroring cycle will start after completion of the last write operation to the destination remote storage device SDRx.

Row V applies the freeze procedure as by the method of row III and the copy procedure for copy to many remote storage devices as by row II.

An example for the mirroring of a selected data object consisting of a group of single data objects residing in a group of storage devices, with the number of single data objects being equal to the number of destination remote storage devices, is shown in Row IV. The simultaneous freeze for more than one data object is similar to the freeze procedure applied in row III, and the copy procedure is similar the one applied in row II.

It is important to note that the freeze procedure is simultaneous for all more than one data objects to be frozen, whether belonging to the same selected data object or stored in more than one local storage device. The cycle time to the next mirroring cycle is dictated by the time needed for the copy procedure to complete the last copy, when multiple copies are performed, such as to many remote storage devices.

It is also noted that simultaneous cross mirroring, from local to remote storage device and vice-versa is also practical with the mirroring functionality for the rows I to VI inclusive. As a simple example for the method of row I, both the local host HL and the remote host HR operate the mirroring functionality, each host acting as the local host while the other host is the remote host.

It will be appreciated by persons skilled in the art, that the present invention is not limited to what has been particularly shown and described hereinabove. For example, more combinations of selected data objects, local and remote storage devices may be considered. Rather, the scope of the present invention is defined by the appended claims and includes both combinations and sub-combinations of the various features described hereinabove as well as variations and modifications thereof which would occur to persons skilled in the art upon reading the foregoing description.

1. A method operative for mirroring a selected data object from at least one local storage device (SDL) into at least one remote storage device (SDRx), the at least one local storage device being coupled to a first processing facility (HL), and the at least one remote storage device being coupled to a second processing facility (HR), and where the at least one local storage device, the at least one remote storage device, the first and the second processing facility are coupled to a network connectivity comprising pluralities of users, of processing facilities and of storage devices, the method comprising the steps of:
running a mirroring functionality in the first and in the second processing facility, the mirroring functionality comprising:
a freeze procedure for freezing the selected data object,
a copy procedure for copying the frozen selected data object into the at least one remote storage device,
permitting use and updating of the selected data object in parallel to running the mirroring functionality, and
commanding, by default, repeated run of the mirroring functionality for copying updates to the selected data object, unless receiving command for mirroring break, whereby the selected data object residing in the at least one local storage device is copied and sequentially updated into the at least one remote storage device.

2. The method according to claim 1, wherein the mirroring functionality further comprises:
applying the freeze procedure for freezing the selected data object as a source volume (SV),
creating at least one local auxiliary volume (AVL) to which updates addressed to the selected data object are redirected, each single data object out of the selected data object corresponding to one local auxiliary volume out of the at least one local auxiliary volume,
creating at least one remote volume in each remote storage device out of the at least one remote storage device, to correspond to each one local auxiliary volume created,
forming in the at least one local storage device, of at least one resulting source volume comprising the frozen selected data object and the at least one local auxiliary volume, and
applying the copy procedure for copying the frozen selected data object from the at least one resulting volume into the at least one remote storage device.

3. The method according to claim 1, further comprising:
applying the mirroring functionality simultaneously to more than one data object.

4. The method according to any one of claims 1, 2 or 3, further comprising:
mirroring simultaneously from at least one local storage device to at least one remote storage device, and vice-versa.

5. The method according to claim 2, wherein the mirroring functionality further comprises:
applying the freeze procedure for freezing simultaneously more than one data object.

6. The method according to claim 2, wherein the mirroring functionality further comprises:
applying the copy procedure to copy simultaneously more than one frozen selected data object.

7. The method according to claim 1 or 2, further comprising:
mirroring simultaneously one single data object residing in one local storage device into more than one remote storage device.

8. The method according to claim 1 or 2, further comprising:
mirroring simultaneously more than one single data object from one local storage device into one remote storage device.

9. The method according to claim 1 or 2, further comprising:
mirroring simultaneously a plurality of single data objects residing respectively in a same plurality of local storage devices into one remote storage device.

10. The method according to claim 1 or 2, further comprising:
mirroring simultaneously a plurality of single data objects residing in one local storage device respectively into a same plurality of remote storage devices.

11. The method according to claim 1 or 2, further comprising:
mirroring simultaneously one single data object residing in each one local storage device out of a plurality of local storage devices into one remote storage device.

12. The method according to claim 1, wherein mirroring further comprises:
at a selected point in time:
starting a mirroring cycle,
freezing the selected data object,
creating at least one local auxiliary volume (AVL) in the at least one local storage device (SDL) and at least one remote volume (RV) in the at least one remote storage device (SDRx),
forming at least one resulting source volume comprising the frozen selected data object and the local auxiliary volume (AVL), and
after the selected point in time:
copying the frozen selected data object from the resulting source volume into the at least one local auxiliary volume until completion of copy,
redirecting to the local auxiliary volume of the updates addressed to the selected data object,
permitting use of the selected data object during mirroring, by associative operation with the resulting source volume, and
repeating a next mirroring cycle by default command, after completion of copy to the at least one remote storage device, unless receiving command for mirroring break.

13. The method according to claim 12, wherein mirroring further comprises:
starting a next mirroring cycle at a next point in time occurring after completion of copy to the at least one remote storage device,
freezing the resulting source volume,
creating an ultimate local auxiliary volume in the local storage device and an ultimate remote volume in the at least one remote storage device,
forming an ultimate resulting source volume comprising the penultimate resulting source volume and the ultimate local auxiliary volume, and
after the next point in time:
copying the penultimate local auxiliary volume into the ultimate remote volume, and,
redirecting to the ultimate local auxiliary volume of the updates addressed to the selected data object,
permitting use of the selected data object during mirroring, by associative operation with the ultimate resulting source volume, and
after completion of copy into the ultimate remote volume:
synchronizing the penultimate local auxiliary volume into the frozen selected data object,
synchronizing the at least one ultimate remote volume into the penultimate remote volume by command of the second processing facility (HR), and
repeating, by default command, of a next mirroring cycle after completion of copy to the at least one second storage device, unless receiving command for mirroring break.

14. The method according to claim 13, wherein mirroring further comprises:
selecting still another point in time occurring after completion of copy of the penultimate local auxiliary volume,
freezing the resulting source volume,
creating an ultimate local auxiliary volume in the local storage device and an ultimate remote volume in the at least one remote storage device,
forming an ultimate resulting source volume comprising the penultimate resulting source volume and the ultimate local auxiliary volume, and
copying the penultimate local auxiliary volume into the at least one ultimate remote volume,
redirecting to the ultimate local auxiliary volume of updates addressed to the selected data object,
permitting use of the selected data object during mirroring in associative operation with the ultimate resulting source volume,
synchronizing the penultimate local auxiliary volume into the selected data object,
synchronizing the at least one ultimate remote volume into the penultimate remote volume, and
repeating a next mirroring cycle by default command after completion of copy to the at least one second storage device, unless receiving command for mirroring break.

15. The method according to claim 14, wherein mirroring further comprises:
storing in the at least one remote storage device of a complete mirrored copy of the selected data object comprising updates entered thereto at the time when copy of the before to penultimate local auxiliary volume was completed.

16. The method according to claim 1, wherein:
mirroring is applicable to a data object selected from the group consisting of data volumes, virtual volumes, data files, system files, application programs, operation systems, data structures, and data base records.

17. The method according to claim 1, wherein:
mirroring is applicable to a network connectivity selected from the group consisting of local area networks, wide area networks and storage area networks.

18. The method according to claim 1, wherein mirroring further comprises:
repeating operation of the mirroring functionality at discrete repetition intervals of time defined as lasting at least as long as duration of copying of the ultimate local auxiliary volume to the ultimate remote volume.

19. The method according to claim 1, wherein mirroring further comprises:
synchronizing updates to overwrite the selected data object, and
synchronizing a later remote volume to overwrite the penultimate resulting first remote volume.

20. The method according to claim 1, wherein:
the selected data object comprises a contents span selected from the group of contents spans consisting of a part of the contents, the whole contents, and more than the contents of the local storage device.

21. The method according to claim 1, wherein mirroring further comprises:
at the local storage device (SDL) at time t=1:
setting a counter to s=1 and creating a local auxiliary volume s,
freezing the selected data object and comprising the local auxiliary volume s and the selected data object into a resulting source volume s,
permitting use of the data object in association with the resulting source volume s, and
at the at least one remote storage device:
creating at time t of a remote volume s, at least equal in size to the data object, and
starting from the time t:
copying the frozen data object from the resulting source volume s into the remote volume s until completion of copy,
whereby the data object frozen at time t is mirrored in the at least one remote storage device.

22. The method according to claim 15, wherein mirroring further comprises:
at the local storage device at time t=t+1 occurring after completion of copy to the at least one remote storage device:
a. increasing the counter to s=s+1,
b. creating a local auxiliary volume s,
c. freezing the resulting source volume s−1, and comprising the local auxiliary volume s and the resulting source volume s−1 into a resulting virtual volume s, and
d. permitting use of the data object in association with the resulting local volume s, and
at the at least one remote storage device:
e. creating at time t of a remote volume s at least equal in size to the source volume, and
starting from the time t:
f. copying the local auxiliary volume s−1 from the resulting source volume s into the remote volume s and completing copy,
g. operating the second processing facility for synchronization, by overwriting, of the remote volume s onto the remote volume s−1, and
at the first storage device (SDL):
h. operating the first processing facility for synchronizing, by overwriting, of the remote volume s onto the local auxiliary volume s−1, and
repeating mirroring after completion of step f, by default repetition of the steps a to h, unless mirroring break is commanded.

23. The method according to claim 22, wherein:
a volume is selected from the group consisting of volumes, virtual or logical volumes, and files.

24. The method according to claim 22, further comprising:
storing in the at least one remote storage device at the time t of a complete mirrored copy of the selected data object comprising updates entered thereto at the time t−2.

25. A system for mirroring a selected data object from at least one local storage device (SDL) into at least one remote storage device (SDRx), the at least one local storage device being coupled to a first processing facility (HL), and the at least one remote storage device being coupled to a second processing facility (HR), and where the at least one local storage device, the at least one remote storage device, the first and the second processing facility are coupled to a network connectivity comprising pluralities of users, of processing facilities and of storage devices, the system comprising:
a mirroring functionality running in the first and in the second processing facility, the mirroring functionality comprising:
a freeze procedure for freezing the selected data object,
a copy procedure for copying the frozen selected data object into the at least one remote storage device,
the selected data object being used and updated in parallel to running of the mirroring functionality, and
the mirroring functionality being run by default command, for copying updates to the selected data object, unless receiving command for mirroring break,
whereby the selected data object residing in the at least one local storage device is copied and sequentially updated into the at least one remote storage device.

26. The system according to claim 25, wherein the mirroring functionality further comprises:
the freeze procedure being applied for freezing the selected data object as a source volume (SV),
at least one local auxiliary volume (AVL) to which updates addressed to the selected data object are redirected, each single data object out of the selected data object corresponding to one local auxiliary volume out of the at least one local auxiliary volume,
at least one remote volume being created in each remote storage device out of the at least one remote storage device, to correspond to each one local auxiliary volume created,
a resulting source volume being formed in the at least one local storage device to comprise the frozen selected data object and the at least one local auxiliary volume, and
the copy procedure being applied for copying the frozen selected data object from the resulting at least one resulting volume into the at least one remote storage device.

27. The system according to claim 25, further comprising:
the mirroring functionality being applied simultaneously to more than one data object.

28. The system according to any one of claims 25, 26 or 27, further comprising:
the mirroring functionality being configured to mirror simultaneously from at least one local storage device to at least one remote storage device, and vice-versa.

29. The system according to claim 26, further comprising:
the freeze procedure being applied for freezing simultaneously more than one data object.

30. The system according to claim 26, further comprising:
the copy procedure being applied to copy simultaneously more than one frozen selected data object.

31. The system according to claim 25 or 26, wherein the mirroring functionality further comprises:
a configuration for simultaneous mirroring of one single data object residing in one local storage device into more than one remote storage device.

32. The system according to claim 25 or 26, wherein the mirroring functionality further comprises:
a configuration for mirroring of more than one single data object simultaneously from one local storage device into one remote storage device.

33. The system according to claim 25 or 26, wherein the mirroring functionality further comprises:
a configuration for mirroring simultaneously a plurality of single data objects residing respectively in a same plurality of local storage devices into one remote storage device.

34. The system according to claim 25 or 26, wherein the mirroring functionality further comprises:
a configuration for mirroring simultaneously a plurality of single data objects residing in one local storage device respectively into a same plurality of remote storage devices.

35. The system according to claim 25 or 26, wherein the mirroring functionality further comprises:
a configuration for mirroring simultaneously one single data object residing in each one local storage device out of a plurality of local storage devices into one remote storage device.

36. The system according to claim 25, wherein mirroring further comprises:
at a selected point in time:
a mirroring cycle being started,
the selected data object being frozen,
at least one local auxiliary volume (AVL) being created in the at least one local storage device and at least one remote volume (RV) being created in the at least one remote storage device,
at least one resulting source volume being formed to comprise the frozen selected data object and the local auxiliary volume, and
after the selected point in time:
the frozen selected data object being copied from the resulting source volume into the at least one remote volume until completion of copy,
the updates addressed to the selected data object being redirected to the local auxiliary volume,
use of the selected data object being permitted during mirroring, by associative operation with the resulting source volume, and
a next mirroring cycle being repeated by default command, after completion of copy to the at least one remote storage device, unless receiving command for mirroring break.

37. The system according to claim 36, wherein mirroring further comprises:
a next mirroring cycle starting at a next point in time occurring after completion of copy to the at least one remote storage device, and
the resulting source volume being frozen,
an ultimate local auxiliary volume being created in the local storage device and an ultimate remote volume being created in the at least one remote storage device,
an ultimate resulting source volume being formed to consist of the penultimate resulting source volume and of the ultimate local auxiliary volume, and
after the next point in time:
the penultimate local auxiliary volume being copied into the ultimate remote volume, and,
the updates addressed to the selected data object being redirected to the ultimate local auxiliary volume in the ultimate resulting source volume,
the selected data object being permitted for use during mirroring by associative operation with the ultimate resulting source volume and,
after completion of copy into the ultimate remote volume:
the penultimate local auxiliary volume being synchronized into the frozen selected data object,
the at least one ultimate remote volume being synchronized into the penultimate remote volume by command of the remote processing facility (HR), and
a next mirroring cycle being repeated, by default command after completion of copy to the at least one second storage device (SDR), unless a command for mirroring break is received.

38. The system according to claim 37, wherein mirroring further comprises:
a still another point in time occurring after completion of copy of the penultimate auxiliary volume being selected,
the resulting source volume being frozen,
an ultimate local auxiliary volume being created in the local storage device and an ultimate remote volume being created in the at least one second storage device,
an ultimate resulting source volume being formed to comprise the penultimate resulting source volume and the ultimate local auxiliary volume, and
the penultimate local auxiliary volume being copied into the at least one ultimate remote volume,
the updates addressed to the selected data object being redirected to the ultimate local auxiliary volume in the ultimate resulting source volume,
the selected data object being permitted for use during mirroring in associative operation with the ultimate resulting source volume and,
the penultimate local auxiliary volume being synchronized into the selected data object,
the at least one ultimate remote volume being synchronized into the penultimate remote volume, and
a next mirroring cycle being repeated by default command after completion of copy to the at least one second storage device (SDR), unless a command for mirroring break is received.

39. The system according to claim 38, wherein mirroring further comprises:
the at least one remote storage device storing a complete mirrored copy of the selected data object comprising updates entered thereto at the time when copy of the before to penultimate local auxiliary volume was completed.

40. The system according to claim 25, further comprising:
the mirroring functionality being applicable to a data object selected from the group consisting of data volumes, virtual volumes, data files, system files, application programs, operation systems, data structures, and data base records.

41. The system according to claim 25, further comprising:
the mirroring functionality being applicable to a network connectivity selected from the group consisting of local area networks, wide area networks and storage area networks.

42. The system according to claim 25, further comprising:
the operation of the mirroring functionality being repeated at discrete repetition intervals of time defined as lasting at least as long as duration of copying of the ultimate local auxiliary volume to the ultimate remote volume.

43. The system according to claim 25, further comprising:
the updates being synchronized to overwrite the selected data object, and
a later remote volume being synchronizing to overwrite the penultimate resulting first remote volume.

44. The system according to claim 25, further comprising:
the selected data object comprising a contents span selected from the group of contents spans consisting of a part of the contents, the whole contents, and more than the contents of the local storage device.

45. The system according to claim 25, further comprising:
at the local storage device (SDL) at time t=1:
a mirroring cycle counter being set to s=1 and a local auxiliary volume s being created,
the selected data object being frozen and comprising the local auxiliary volume s a resulting source volume s and the selected data object into a resulting source volume s,
the data object being permitted for use in association with the resulting source volume s, and
at the at least one remote storage device:
a remote volume s being created at time t, and being at least equal in size to the data object, and
starting from the time t:
the frozen data object being copied from the resulting source volume s into the remote volume s until completion of copy,
whereby the data object frozen at time t is mirrored in the at least one remote storage device.

46. The system according to claim 45, further comprising:
at the local storage device at time t=t+1 occurring after completion of copy to the at least one remote storage device:
a. the mirroring cycle counter being increased to s=s+1,
b. a local auxiliary volume s being created,
c. the resulting source volume s−1 being frozen, and comprising the local auxiliary volume s and the resulting source volume s−1 into a resulting virtual volume s, and
d. the data object being permitted for use in association with the resulting local volume s, and
at the at least one remote storage device:
e. a remote volume s being created at time t with a size at least equal to the size of the source volume, and
starting from the time t:
f. the local auxiliary volume s−1 being copied from the resulting source volume s into the remote volume s until copy completion,
g. the second processing facility being operated for synchronization, by overwriting, of the remote volume s onto the remote volume s−1, and
at the first storage device (SDL):
h. the first processing facility being operated for synchronization, by overwriting, of the remote volume s onto the local auxiliary volume s−1, and
mirroring being repeated after completion of step f, by default repetition of the steps a to h, unless mirroring break is commanded.

47. The system according to claim 46, further comprising:
a volume being selected from the group consisting of volumes, virtual or logical volumes, and files.

48. The system according to claim 46, further comprising:
a complete mirrored copy of the selected data object comprising updates entered thereto at the time t−2 being stored in the at least one remote storage device at time t.
